(19) United States
(12) Patent Application Publication
(10) Pub. No.: US 2011/0004934 A1
(43) Pub. Date: Jan. 6, 2011

(54) Computer Access Educational Tools System

(76) Inventor: Zareh H. Beylerian, Paramus, NJ (US)

Correspondence Address: Zareh H. Beylerian, 586 Mazur Avenue, Paramus, NJ, 07652, US

(21) Appl. No.: 12/643,984

(22) Filed: Dec. 21, 2009

Related U.S. Application Data
(60) Provisional application No. 61/203,511, filed on Dec. 23, 2008.

(51) Int. Cl. G06F 21/00

(52) U.S. Cl. 726/21

(57) ABSTRACT

Computers are currently often used for entertainment when they have been primarily provided to the user—often a child—primarily for education or work use. This invention aims to build in a gateway that makes access to the computer conditional upon passing a test or demonstrating completion of prior tasks such as homework or assignments.

This system allows parents, educators, or managers of computer systems to tailor conditions as a pre-requisite to access by a user to a computer. The scope, contents, and measure of satisfactory performance of the conditions are determined by the administrator using a web-interface. The conditions must be met before a user is permitted to access all or other selected features of the computer.

### BACKGROUND OF THE INVENTION

Computers are currently often used for entertainment when they have been primarily provided to the user—often a child—primarily for education or work use. This invention aims to build in a gateway that makes access to the computer conditional upon passing a test or demonstrating completion of prior tasks such as homework or assignments.

This system allows parents, educators, or managers of computer systems to tailor conditions as a pre-requisite to access by a user to a computer. The scope, contents, and measure of satisfactory performance of the conditions are determined by the administrator using a web-interface. The conditions must be met before a user is permitted to access all or other selected features of the computer.

### FEATURES OF THE SYSTEM

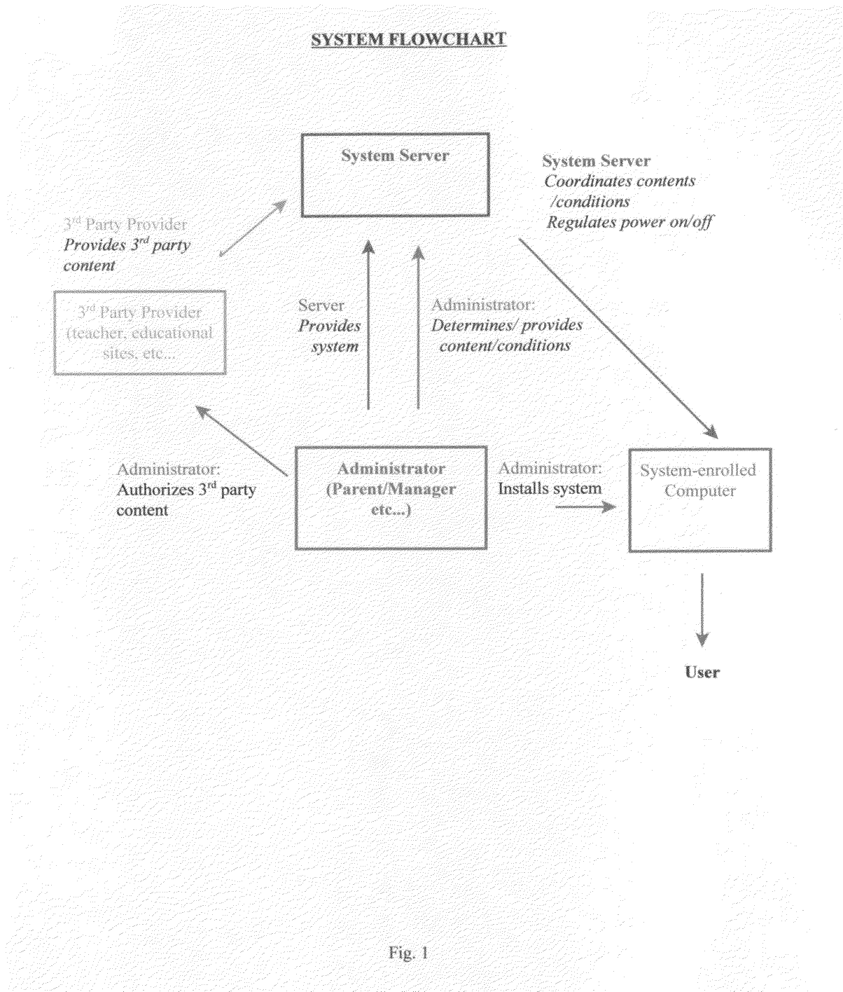

1. The system consists of a software program to load on startup and a web-interface (FIG. 1).

2. The administrator installs the program on any computer to which access is to made conditional (FIG. 1).

3. Through a web interface, the administrator selects conditions which the user must meet in order to be allowed access to other features, such as the internet, games, etc . . . (FIG. 1).

4. The conditions can include passing a quiz or completing certain pre-determined tasks.

5. The web interface includes general, user-originated, and third-party content.

(a) General content. The administrator can choose various educational tools such as general or topic-specific quizzes at various age and proficiency levels.

(b) User-Originated content. The administrator can create customized tests or tasks, such as tests, to-do lists, and the like.

(c) Third-Party content. The administrator can link to third-party content or tasks such as homework submitted from teachers or tasks from other administrators (FIG. 1).

6. Successful completion of the tasks or tests unlocks the computer for other uses, as determined by the administrator. Alternatively, the user is re-directed to the interface for task completion or study.

7. The computer will lock again and re-direct to the interface after a certain amount of usage, as determined by the administrator. A warning indicator will give advance notice.

8. The administrator can override the system via password or e-mail authorization.

9. The system tracks performance and usage history for evaluation.

What is claimed is:

1. A gateway system to be made a part of computers or similar devices which gives the owner of the machine the option of making access to it conditional upon demonstrating certain knowledge or completion of pre-determined tasks such as homework or an assignment.

2. The system according to claim 1 will bar the use of all or part of the computer device if the user fails to meet the requirements set by the owner, which requirements can be set or modified via a web interface.

3. The system according to claim 1 will also allow the owner to set time limits for certain uses or all use of the device per day.

4. The system according to claim 1 tracks performance and usage history for evaluation by the owner as to the progress and proficiency of the user.
